(19) United States
(12) Patent Application Publication
(10) Pub. No.: US 2017/0032395 A1
(43) Pub. Date: Feb. 2, 2017

(54) SYSTEM AND METHOD FOR DYNAMICALLY CREATING, UPDATING AND MANAGING SURVEY QUESTIONS

(71) Applicant: PeerAspect LLC, Baltimore, MD (US)

(72) Inventors: Scott Kaufman, Baltimore, MD (US); Sujeesh Krishnan, Washington, DC (US); Micah Calabrese, Los Angeles, CA (US); John Russell Norris, Decatur, GA (US)

(21) Appl. No.: 14/815,709

(22) Filed: Jul. 31, 2015

(51) Int. Cl. G06Q 30/02; G06F 3/0484; G06F 3/0482

(52) U.S. Cl. CPC G06Q 30/0203; G06F 3/0482; G06F 3/04842

(57) ABSTRACT

A system and method for dynamically creating, updating, and managing survey questions. The present disclosure is directed towards dynamically adding and removing questions and answers for electronic surveys using a unique system of tags applied to a database of questions and answers. Survey (Sheet) questions for a chosen category are stored in a centralized database—survey senders populate this database with all possible questions for the chosen survey project they need to collect data for, and can continuously maintain this master list by adding and removing questions over time.

### FIELD OF THE INVENTION

The present disclosure relates to the field of data collection and, more particularly, to a system and method for dynamically creating, updating, and managing survey questions.

### BACKGROUND

A variety of situations exist where it is desirable to obtain data from a population sample or a defined set of individuals and/or organizations. For example, targeted data collection from a multitude of respondents is necessary for organizations needing to track compliance, vendor management, member/alumni information, research surveys, markup forecasts, political opinion polls, and the like.

Even though data collection efforts are common, existing methods to develop and administer a data collection effort are technologically primitive and conducted in an ad-hoc manner. Existing survey tools are generally meant for simple “open and shut” questionnaires, without the functionality to continuously track collected data. One existing method is to send survey questions to respondents using email. The questions are written in an email body and sent to a mailing list of targeted users. Responses are received via email and subsequently analyzed and otherwise processed. This method is costly, difficult to perform rapidly, and is subject to response errors. Other existing approaches use customized data collection applications, which can be word processing documents sometimes with data gathering macros, database applications, and/or customized software applications.

These existing systems produce “static” surveys, meaning multiple surveys have to be created for different reporting needs and/or even for subsequent reporting periods (e.g. a new survey sent every quarter or year), even when many of the questions and answers are the same. They therefore don't address the need for continuous and recurrent data collection, especially for organizations needing to track information on a regular basis (e.g. a company that needs to track supplier compliance with regulations in multiple parts of the world or where supplier processes/information change frequently resulting in the company having to get updated information to/from their suppliers on a regular basis). These existing systems do not work for continuous data collection because they are designed to be sent once, filled out by any given respondent or respondents once, and then closed.

What is needed is a novel system which addresses the need for continuous data collection.

What is further needed is a novel system which allows questions to be dynamically mapped, grouped together and sent out to respondents at different times for different reporting needs but still collected and maintained within the same system without the need for any additional aggregation.

What is further needed is a system and method which generally overcomes the above mentioned shortcomings in prior art survey tools.

### SUMMARY

A system and method for dynamically creating, updating, and managing (including sharing) questionnaires in accordance with embodiments of the inventive arrangements disclosed herein. More specifically, the present disclosure provides a data collection solution that allows questions to be mapped to different reporting needs. The data collection solution facilitates the setup, data entry, and the aggregation of responses from multiple surveys. This data collection solution further allows for continuous updating of questions, and for applying answers from one request to another. Such a continuous collection process is superior to other collection processes that exist because it saves significant time. This eliminates the need for multiple surveys to be sent out during the process of collecting updates and thus minimizes the effort on the respondents end in filling out the requested information. It also eliminates the need for senders to post-process survey information to collate multiple surveys together—the solution ensures that all of the collected information is already collated and lives in one place from the start.

This data collection solution further allows respondents to share questions with (a) other collaborators: which eliminates the need for separate aggregation of information from multiple people in order to complete a questionnaire; and/or (b) other senders: which enables responders to use the data collection system as a single data source from where they have to respond to similar requests from multiple senders.

The present disclosure can be implemented in accordance with numerous aspects consistent with the material presented herein. For example, one aspect of the present disclosure includes a centralized database for storing survey questions. Survey senders populate this database with all possible questions for the chosen category, and continuously maintain this master list by adding and removing questions over time. Questions are tagged with identifying characteristics such as a regulatory region like Europe or Canada or type of information being collected like Supply Chain Risk or Chemical Composition. Questions aresent to respondents when the sender chooses one or more tags and selects the respondent by entering their email address and, if needed, some additional information about the data being requested (e.g. product name, part number, etc.). It should be noted that multiple questions could have the same tag a any question could have multiple tags.

It is also noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave (either on the intern& or through a mobile network). The described program can be a single program or can be implemented as multiple subprograms, each of which interact within a single computing device or interact in a distributed fashion across a network space.

### BRIEF DESCRIPTION OF THE DRAWINGS

FIG. 1 is a screenshot of a list of questions according to an exemplary embodiment of the present invention

FIG. 2 is a screenshot of questions sent to a respondent according to an exemplary embodiment of the present invention.

FIG. 3 is a screenshot of a respondent's view of the selected questions according to an exemplary embodiment of the present invention.

FIG. 4 is a screenshot of a completed respondent set of questions according to an exemplary embodiment of the present invention.

FIG. 5 is a screenshot of a completed sender set of questions according to an embodiment of the present invention.

FIG. 6 is a screenshot of the way additional questions are sent to the same respondent according to an embodiment of the present invention.

FIG. 7 is a screenshot of an updated respondent set of questions according to an embodiment of the present invention

FIG. 8 is a screenshot of an automatically applied answer to a question that was previously answered according to an embodiment of the present invention.

FIG. 9 is a screenshot of a completed sender set of questions according to an embodiment of the present invention.

FIG. 10 is an architecture diagram of the solution according to an embodiment of the present invention.

### DETAILED DESCRIPTION

The following description is provided to assist in a comprehensive understanding of exemplary embodiments of the invention as defined by the claims and their equivalents. It includes various specific details to assist in that understanding; however these specific details are to be regarded as merely exemplary. Accordingly, those of ordinary skill in the art will recognize that various changes and modifications of the embodiments described herein can be made without departing from the scope and spirit of the invention.

It should be understood that the embodiments presented are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The present disclosure is directed towards dynamically adding and removing questions and answers for electronic surveys using a unique system of tags applied to a database of questions and answers. Survey (Sheet) questions for a chosen category are stored in a centralized database—survey senders populate this database with all possible questions for the chosen survey project they need to collect data for, and can continuously maintain this master list by adding and removing questions over time. To be included in a sheet that is sent out, questions must be tagged with an identifying characteristic such as a compliance reporting program, a reporting standard, a geographical entity such as a country, etc. Questions are sent to respondents when the sender chooses one or more tags and selects the respondent by entering their email address and if needed some additional information about the data being requested (e.g. product name, part number, etc.) and sending notification through the system. This does one of two things—option 1: if there is no existing sheet for the user—identifying characteristics combination, a new sheet is created with questions marked with the selected tag(s) that the respondent fills out; option two: if there is an existing sheet, questions are added or removed when a tag is selected or deselected.

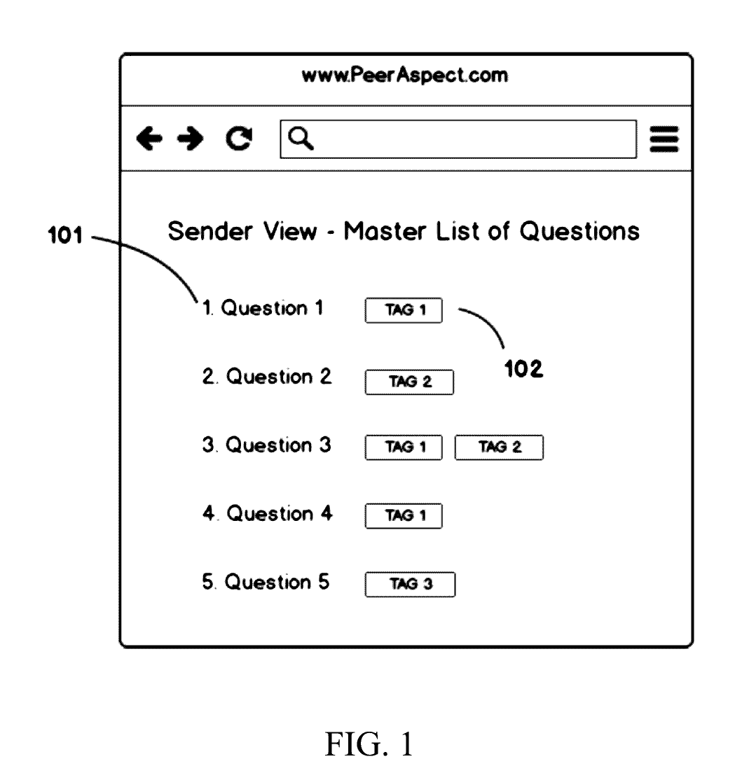

FIG. 1 is a screenshot of a list of questions according to an exemplary embodiment of the present invention. Referring now to FIG. 1, a sender creates a master list 101 of questions for a given survey project (e.g. chemicals compliance). The sender then applies identification tags 102 to each question (more than one tag per question is permissible). Data can be inputted from a user computer system, a wireless phone, a network server, and can arrive or be extracted from multiple data sources, implementing multiple formats, etc.

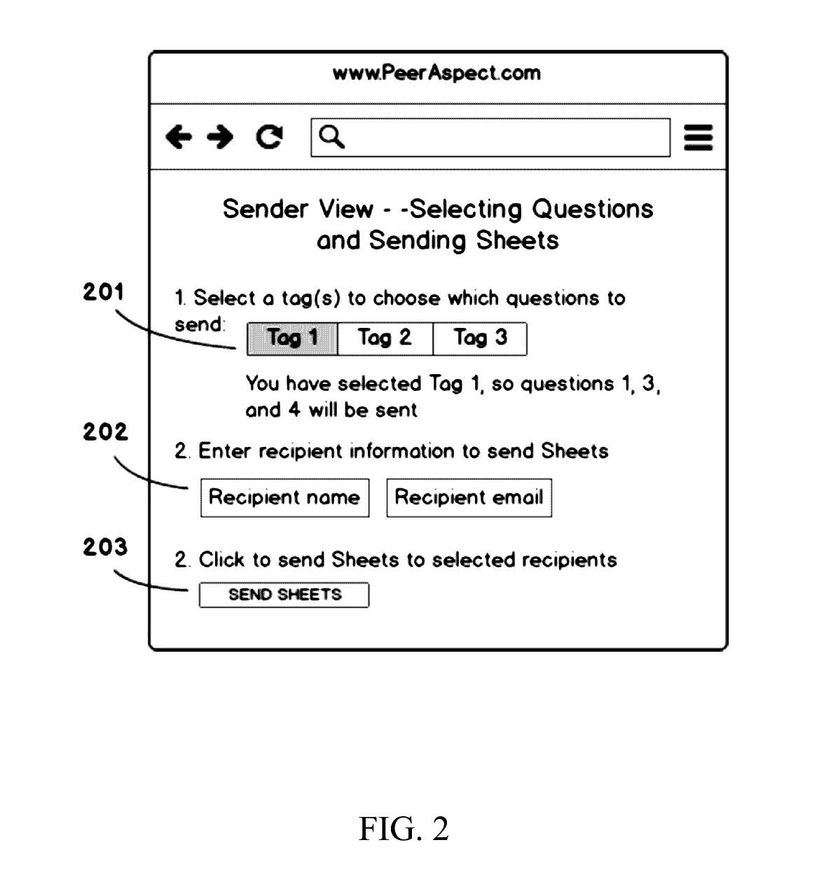

FIG. 2 is a screenshot of questions sent to a respondent according to an exemplary embodiment of the present invention. In FIG. 2, the sender chooses which questions are sent to a respondent by selecting from a set of available tags 201 that were set up in the previous question creation process, then entering in recipient information 202 such as the name and the email address of the respondents, and finally clicking on the send button 203.

In one embodiment, the respondents receive an email notification with a direct link to an online form that contains the respondent set of questions to be answered. The respondent opens the online form of questions to be answered, and fills out responses. Other ways of receiving could be on a mobile device as a text message that contains a link to an online form. In another embodiment, instead of a direct link to an online form the email notification includes a set of questions in a PDF/Word/Excel attachment which can be downloaded by the respondent, filled-in and sent back.

In another embodiment, a sequence is set up where once a tag is completed, then the system automatically sends another tag to the respondent. In yet another embodiment, tags are sent on a schedule—i.e. on July 1st send Tag 1, August 1st send tag 2, etc.

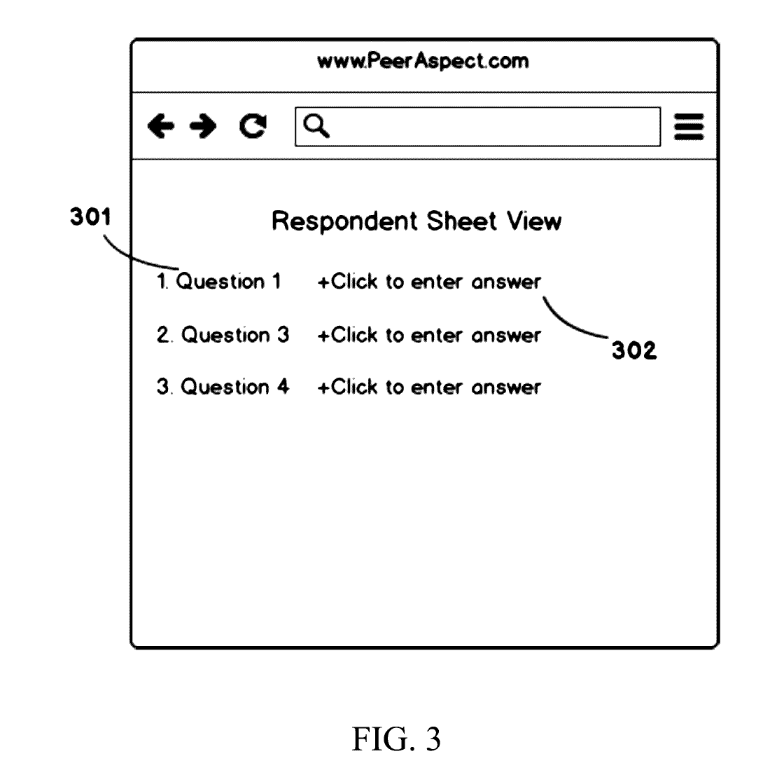

FIG. 3 is a screenshot of a respondent's view of the selected questions according to an exemplary embodiment of the present invention. The respondent's view of the questions in FIG. 3 includes the relevant questions 301 associated with the tags that were selected by the sender to the selected respondents as well as an area 302 to click to enter the answers to the questions. FIG. 3 contemplates a specific embodiment of the respondent's view of the selected questions. In another embodiment, the respondent fills out answers to questions on an online form, the link to which they get in an email. In another embodiment, they fill out this information in a PDF file or Microsoft Office document that is attached to the email they receive that they can send back once filled in.

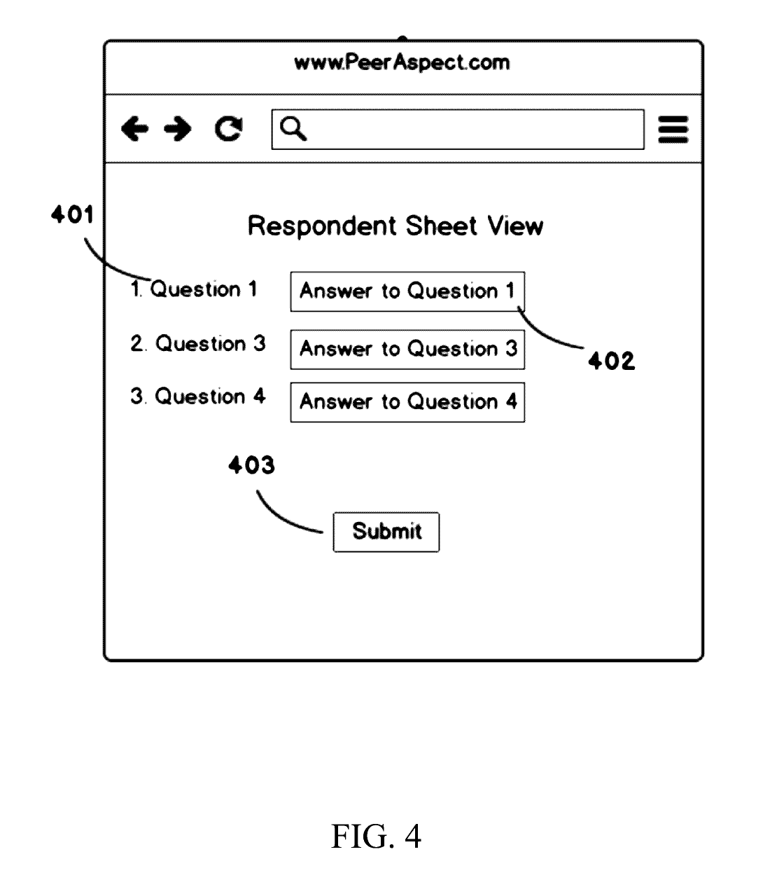

FIG. 4 is a screenshot of a completed respondent set of questions according to an exemplary embodiment of the present invention. In this embodiment, when the respondent has completed filling out the answers 402 for the questions 401 that were previously sent, a “Submit” 403 button appears which the respondent can click on to send the completed information back to the sender. In one embodiment, the sender is notified and after a verification process, accepts or rejects the submitted sheet. Verification in this instance refers to the sender checking each answer provided by the respondent and making sure it is acceptable, this can be done by using a set of rules that are automatically applied to responses for verification purposes (e.g. set status on a response to acceptable if product weight is between 10 g and a 100 g, otherwise set the status to unacceptable.) If accepted, the survey is closed until the sender requests an update, and/or the sender adds new questions. If not accepted, the sender may request respondent to update or correct information provided prior to closing the survey.

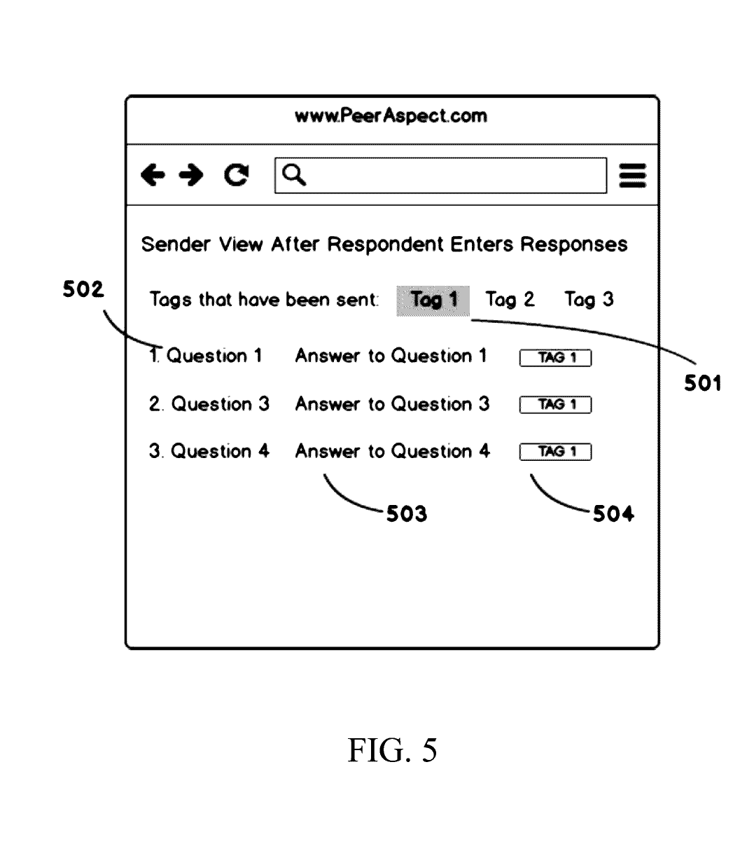

FIG. 5 is a screenshot of the completed sender set of questions according to an embodiment of the present invention. In this screen, the tags 501 that were sent to the respondent are highlighted, and includes a list of the questions 502 that were sent as well as the answers 503 from the respondent for these questions and the tags 504 associated with each individual question. The sender can at any time add brand-new questions and group them with an existing or a new tag. These tags can then be applied to individual respondents or to all respondents.

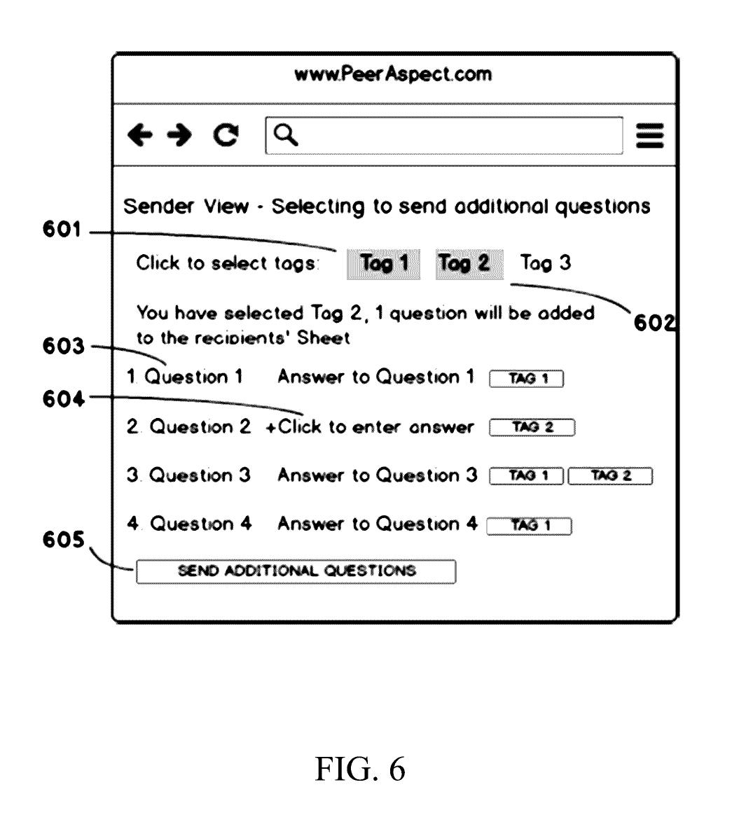

FIG. 6 is a screenshot of additional questions sent to a previous respondent according to an embodiment of the present invention. If the sender wants to add new questions, they are presented with a listing of tags that includes the tags 601 previously send and then they simply select 602 the tag containing the questions to be added. The questions are dynamically added to the existing set of questions 603 based on the tags selected—wherein the software logic takes the set of questions associated with the selected tag and then adds the new question(s) 604 into the set of questions 603 a respondent has access to. In other words, the respondent always has access only to questions that have been shared with them using the tags and the process of adding and/or removing tags in this screen enables the send to identify which sets of questions the respondent has access to. This set of questions 603 can be changed at any point in time by the sender using the features shown in this screen. When changes are made, the sender can send via send button 605 these additional questions and the respondent is notified via email that there are new questions to answer.

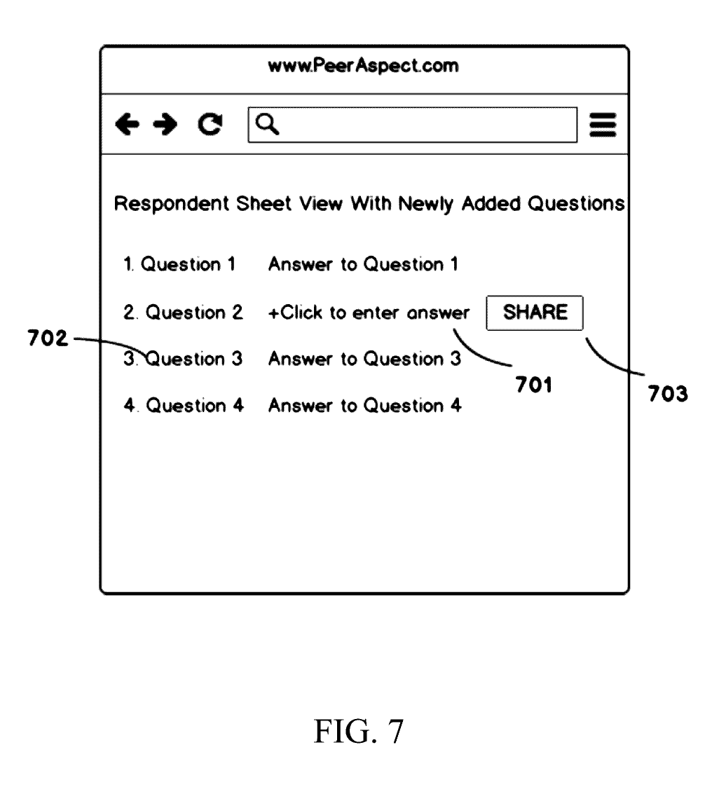

FIG. 7 is a screenshot of an updated respondent set of questions according to an embodiment of the present invention. This updated sheet includes the new questions 701 that have been dynamically added as well as the previously answered questions 702. The respondents also have the ability to share via share button 703 all of the questions or selected questions with others either within their organization or external.

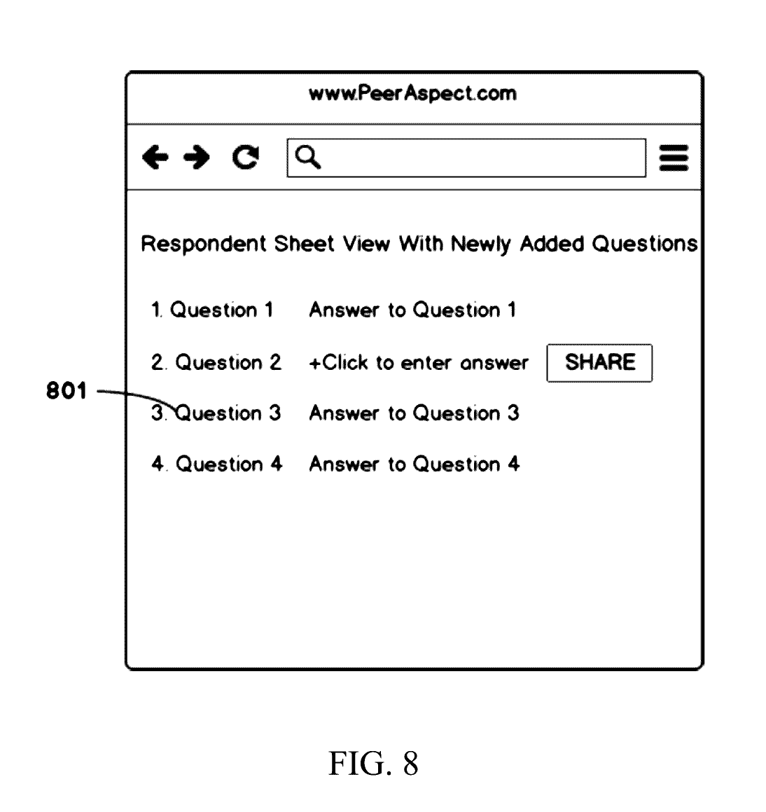

FIG. 8 is a screenshot of an automatically applied answer to a question that was previously answered according to an embodiment of the present invention. When the receiver receives an update request, any responses to questions 801 with the previous tags are automatically applied to the new request. The respondent has the ability to change/update previously filled in information at this point if needed.

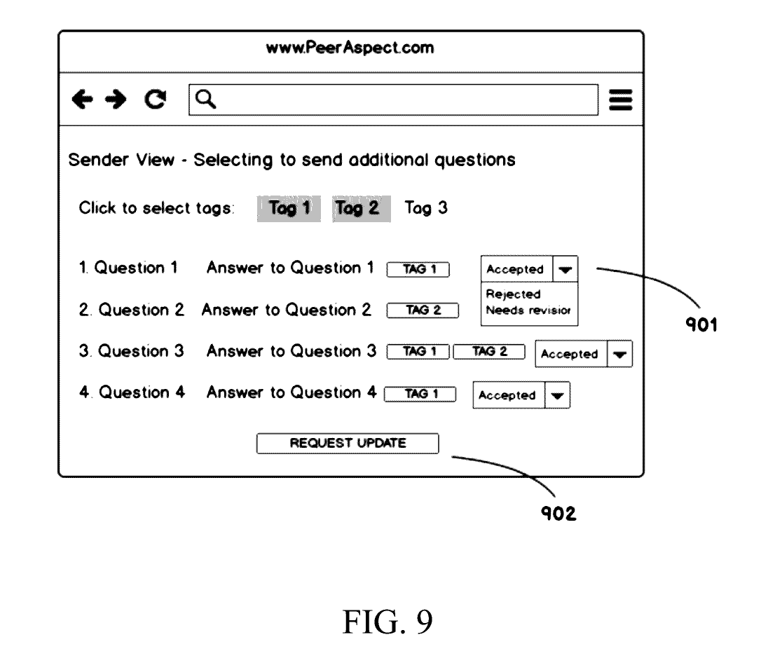

FIG. 9 is a screenshot of a completed sender set of questions according to an embodiment of the present invention. After the respondent has answered the remaining questions, the receiver's answers are automatically incorporated into the master survey. In one embodiment, the sender is notified when the receiver has answered the remaining questions and after a verification process, accepts or rejects the submitted sheet. Verification in this instance refers to the sender checking each answer provided by the respondent and making sure it is acceptable via approval dropdown 901, this can be done by using a set of rules that are automatically applied to responses for verification purposes (e.g. set status on a response to acceptable if product weight is between 10 g and a 100 g, otherwise set the status to unacceptable.) If accepted, the survey is closed until the sender requests an update, and/or the sender adds new questions. If not accepted, the sender may request respondent to update or correct information provided prior to closing the survey. The sender can also at any point in time request updates via request updates button 902 from the respondent to answers submitted and the respondent is presented with their previously submitted answers and asked to make changes if any are needed and re-submit their answers.

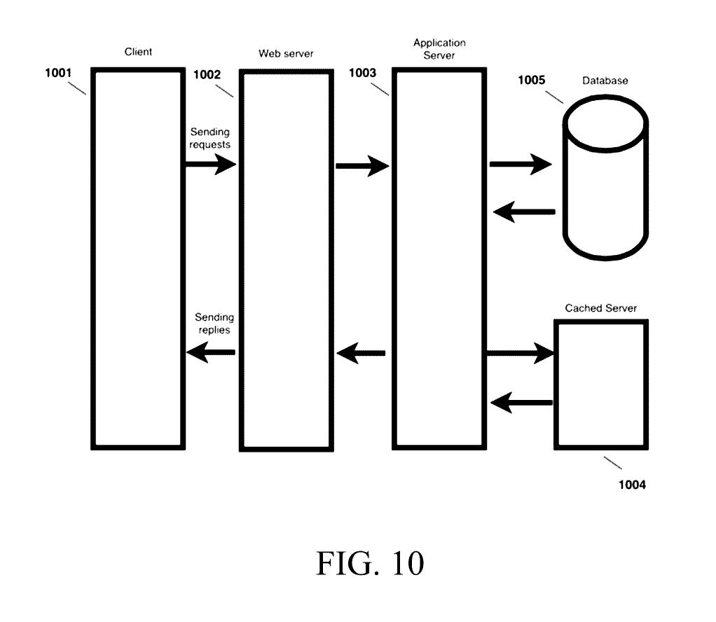

FIG. 10 is an architecture diagram of the solution according to an embodiment. Client 1001 is a software application used by senders and responders for retrieving, presenting and traversing information resources on the World Wide Web. Web Server 1002 is an information technology that processes requests via HTTP or HTTPS, the basic network protocol used to distribute information on the World Wide Web. Application Server 1003 is a software framework that provides both facilities to create web applications and a server environment to run them. Cached Server 1004 is a dedicated network server that saves Web pages and Web page fragments in memory for quicker page composition. Database 1005 stores all the questions that are set up, the identifying tags, as well as the responses to these questions from each respondent. It is a collection of all the information that is organized so that it can easily be accessed, managed, and updated.

The Client 1001 requests a page and static assets from the web server 1002. The Web Server 1002 then delivers static assets and forwards page request to application server 1003. The Application Server 1003 reads and writes data to the Database 1005 and Cache Server 1004. The Application Server 1003 composes a response and then sends that response to the Web Server 1002. The Web server 1002 forwards this response to the Client 1002.

It can be appreciated that the present disclosure allows a user (sender) to create a set of questions that they need answers for, from one or more respondents. It can be appreciated that the present disclosure allows the sender to ask different subsets of these questions at different times. Further, the sender can add or remove questions and responses from active surveys over time. When the sender activates or deactivates these tags, selected respondents see the questions they need to answer appear in their sheet, or see the questions disappear for tags that were removed. Additionally, questions with multiple tags share their answers across requests—when a respondent answers the question with multiple tags, the answer is applied to new requests from the sender with one of the other multiple tags for the question.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Ruby on Rails, CoffeeScript, Sass, Clojure, Elixir, Node, Go, Erlang, Objective C, Swift, Lisp, Java, JavaScript, VBScript,

Macromedia Cold Fusion, COBOL, Microsoft Active Server Pages, assembly, PERL, PHP, AWK, Python, Visual Basic, VimL, Scala, Prolog, Haskell, Lua, SQL Stored Procedures, PL/SQL, any UNIX shell script, and extensible markup languages (XML, HTML, JSON, CSS) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an intern& based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, mobile device/tablet, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

1. A computer-implemented method of dynamically populating a questionniare, the method comprising:
providing a master list of questions for a given category;
applying at least one identification tag to each question so that it can be dynamically added to a questionnaire;
selecting a set of identifications tags for a respondent;
dynamically populating a questionnaire based on the selected set of identification tags; and
transmitting the survey to the respondent.

2. The computer-implemented method according to claim 1, wherein the method further comprises:
receiving a completed survey from the respondent; and
accepting or rejecting the completed survey.

3. The computer-implemented method according to claim 1, wherein the survey is sent to the respondent via email.

4. A system comprising:
a computing device; and
a computer-readable medium coupled to the computing device and having instructions stored thereon which, when executed by the computing device, cause the computing device to perform operations comprising:
providing a master list of questions for a given category;
applying at least one identification tag to each question;
selecting a set of identifications tags for a respondent;
populating a survey with the relevant questions associated with the selected set of identification tags; and
sending the survey to the respondent.

5. The system of claim 1, wherein the operations further comprise:
receiving a completed survey from the respondent; and
accepting or rejecting the completed survey.

6. The system of claim 1, wherein the survey is sent to the respondent via email.

7. A non-transitory computer readable storage medium encoded with a computer program, the program comprising instructions that when executed by one or more computers cause the one or more computers to perform operations comprising:
providing a master list of questions for a given category;
applying at least one identification tag to each question;
selecting a set of identifications tags for a respondent;
populating a survey with the relevant questions associated with the selected set of identification tags; and
sending the survey to the respondent.
